(19) United States
(12) Patent Application Publication
(10) Pub. No.: US 2013/0117806 A1
(43) Pub. Date: May 9, 2013

(54) NETWORK BASED PROVISIONING

(71) Applicants: Srivatsan Parthasarathy, Seattle, WA (US); Scott Field, Redmond, WA (US); Joseph Dadzie, Redmond, WA (US); David Kays, Redmond, WA (US)

(72) Inventors: Srivatsan Parthasarathy, Seattle, WA (US); Scott Field, Redmond, WA (US); Joseph Dadzie, Redmond, WA (US); David Kays, Redmond, WA (US)

(73) Assignee: MICROSOFT CORPORATION, Redmond, WA (US)

(21) Appl. No.: 13/292,922

(22) Filed: Nov. 9, 2011

(51) Int. Cl. G06F 21/00; G06F 17/00

(52) U.S. Cl. 726/1; 726/3; 726/4

(57) ABSTRACT

The subject disclosure generally relates to provisioning devices via a network service, such as a cloud service. A profile component can authenticate a user of a device with a cloud service, and determine services maintained by the network service that are associated with the user. A reception component can receive a request for a set of services from the device, and a services component can obtain the set of services from the network service, and provision the device based on the set of services. Provisioning the device can include downloading the services to the device, or including the services in a virtual machine executing in the network service.

### TECHNICAL FIELD

The subject disclosure relates to device provisioning, and more particularly to provisioning devices based on data and information maintained via a network computing system, e.g., a cloud computing system.

### BACKGROUND

In the domain of data storage and computing device configuration, there are significant inefficiencies involved in replacing, restoring, and provisioning devices. Typically, data is stored on a device, and as a result, if the device is lost, stolen, or damaged, then data on the device is typically also lost. Conventional systems enable users to backup data to an external data storage; however, the length of time between backups may not be uniform, and data generated on the device since a most recent backup can often still be lost.

Replacing a device with a new device can present additional difficulties. For instance, configuring a new device to include a user's preferences, settings, applications, and data from a previous device can be time consuming and difficult. Part of the difficulty lies in possible incompatibilities or differences between the previous device and the new device. Information Technology (IT) professionals face similar challenges in provisioning devices for enterprise purposes. Particularly, where an IT department supports multiple devices, configurations, or platforms for a variety of purposes.

The above-described deficiencies of today's techniques are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In one or more embodiments, systems and methods are provided for provisioning devices via a cloud service. In accordance therewith, a system is provided that includes a a profile component configured to authenticate a user of a device with a cloud service, and determine services maintained by the cloud service that are associated with the user, a reception component configured to receive a request for a set of services from the device; and a services component configured to obtain the set of services from the cloud service, and provision the device based on the set of services.

In another embodiment, a method is provided that includes authenticating an identity of a user of a first device with a cloud service, determining a set of privileges associated with the user, obtaining a request to provision the first device based on a configuration of a second device maintained by the cloud service, and provisioning the first device based on the configuration of the second device.

In yet another embodiment, a system is provided that includes verifying an identity of a user of a device with a cloud, obtaining a request to provision the device, obtaining a set of services from the cloud based on the request, and determining to download a first subset of the services to the device based on a set of criterion.

Other embodiments and various non-limiting examples, scenarios and implementations are described in more detail below.

### BRIEF DESCRIPTION OF THE DRAWINGS

Various non-limiting embodiments are further described with reference to the accompanying drawings in which:

FIG. 1 illustrates a block diagram of an exemplary non-limiting system that can provision devices via a cloud service;

FIG. 2 illustrates a block diagram of an exemplary non-limiting system that can provision devices via a cloud service;

FIG. 3 illustrates a block diagram of an exemplary non-limiting system that can provision devices via a cloud service;

FIG. 4 illustrates a block diagram of an exemplary non-limiting system that can provision devices via a cloud service;

FIG. 5 is a block diagram of an exemplary non-limiting cloud service;

FIG. 6 is graphical representation of an exemplary non-limiting user interface for provisioning devices via a cloud service;

FIG. 7 illustrates a block diagram of an exemplary non-limiting system that provide additional features or aspects in connection with cloud based provisioning;

FIGS. 8-9 are exemplary non-limiting flow diagrams for cloud based provisioning;

FIG. 10 is a block diagram representing exemplary non-limiting networked environments in which various embodiments described herein can be implemented; and

FIG. 11 is a block diagram representing an exemplary non-limiting computing system or operating environment in which one or more aspects of various embodiments described herein can be implemented.

### DETAILED DESCRIPTION

### Overview

By way of an introduction, the subject matter disclosed herein relates to various embodiments relating to provisioning computing devices via a cloud service. In particular, the subject matter can provide a mechanism for authenticating a user of a device with a cloud service, and determining services associated with user and maintained by the cloud service. The user can request a set of services from the cloud service, and the services can be provisioned to the device. The services can include, but are not limited to operating systems, applications, settings, and data.

In addition, aspects of the disclosed subject matter can provision the device via downloading the services to the device, or the services can be included in a virtual machine executing in the cloud service. Additionally, the services can include enterprise services, and service templates based on configurations of other devices or recommended configurations.

### Introduction to Network Based Device Provisioning

Certain subject matter disclosed herein is directed to cloud computing and virtual machine provisioning. Accordingly, examples associated with network computing, e.g., cloud computing, and virtual machine provisioning can be helpful in understanding some aspects, features, or embodiments of the present disclosure.

Network, e.g., cloud, computing employs a network of remote servers, computers, data storage devices, and so forth to store, manage, and process data. Computing can be delivered as a service over a network, wherein the end-user is not required to have knowledge of the physical location or configuration of the system that delivers the services. In addition, a virtual machine (VM) is a software implementation of a computing device that executes in a similar fashion to a physical computer. VMs can host multiple isolated operating system environments, can enable application provisioning, and can be accessed via a network connection.

### Network Based Device Provisioning

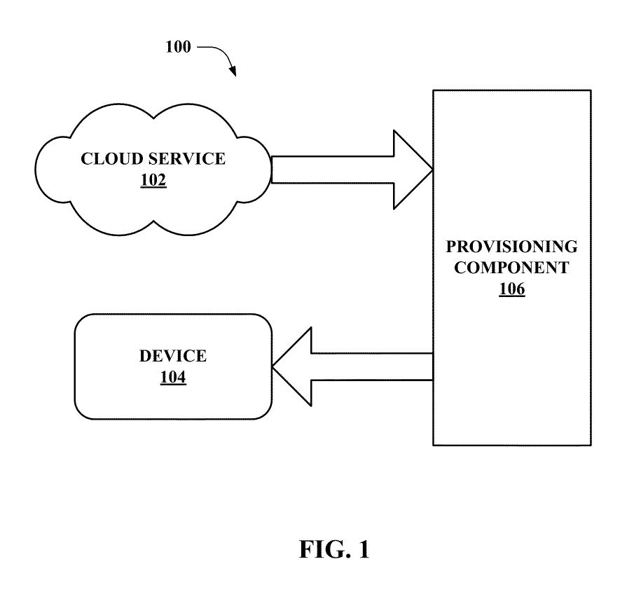

Referring now to the drawings, with reference initially to FIG. 1, system 100 that can provision devices via a cloud service 102 is shown in accordance with various aspects described herein. The cloud service 102 is configured to maintain and/or provide a set of services for a set of devices via a network connection. The services can include, but are not limited to, computation, applications (e.g., software, programs, etc.), data access, settings, and storage (e.g., data backup). For example, data generated by the device 104 can be maintained, or stored, by the cloud service 102. In addition, an operating system employed on the device 104, a set of settings employed on the device 104, a set of applications used on the device (e.g. collectively a configuration of the device) can be maintained via the cloud service 102.

The cloud service 102 can be virtually any type of cloud computing configuration, including a public cloud, a community cloud, a hybrid cloud, a private cloud, etc. For example, the cloud service 102 can be a private enterprise cloud service 102, wherein access to the cloud service 102 is limited to devices or users associated with an enterprise (e.g., organization, corporation, etc.), and the services provided by the cloud service 102 can be associated with the enterprise. For instance, the cloud service 102 can be a private enterprise cloud service employed by an engineering firm to provide engineering applications and data access to a set of enterprise devices.

The device 104 can be a computing and/or mobile device having a network connection, including, but not limited to, a desktop computer, a laptop, a tablet, a net book, a terminal computer, a personal data assistant (PDA), a music player, a global positioning system (GPS), a video game system, a mobile phone, a smart phone, an internet enabled television, and so forth. The device 104 can access the services at the cloud service 102, or download the services from the cloud service 102. For example, the device 104 can access an application that executes in the cloud service 102, or can download and install the application locally.

Generally, the system 100 can include a provisioning component 106 that, as with all components described herein can be stored in a computer readable storage medium. The provisioning component 106 is configured to determine a set of services available via the cloud service 102 for the device 104, and, based on a set of criterion (e.g., user privileges, preferences, behavior profiles, locations, device specifications, cloud service 102 policies, etc.), setup, equip, or otherwise provision the device 104 using one or more services in the set services. For example, the provisioning component 106 can determine that a configuration is available for the device 104, including an operating system, a set of applications, a set of settings (e.g. device encryption levels, configurations, preferences, etc.), and stored data. The provisioning component 106 can provide the configuration to the device 104 based on an authentication of a user of the device 104 with the cloud service 102. It is to be appreciated that although the provisioning component 106 is illustrated as a stand-alone component, such implementation is not so limited. For instance, the provisioning component 106 can be included in the cloud service 102, the device 104, or a disparate entity (not shown).

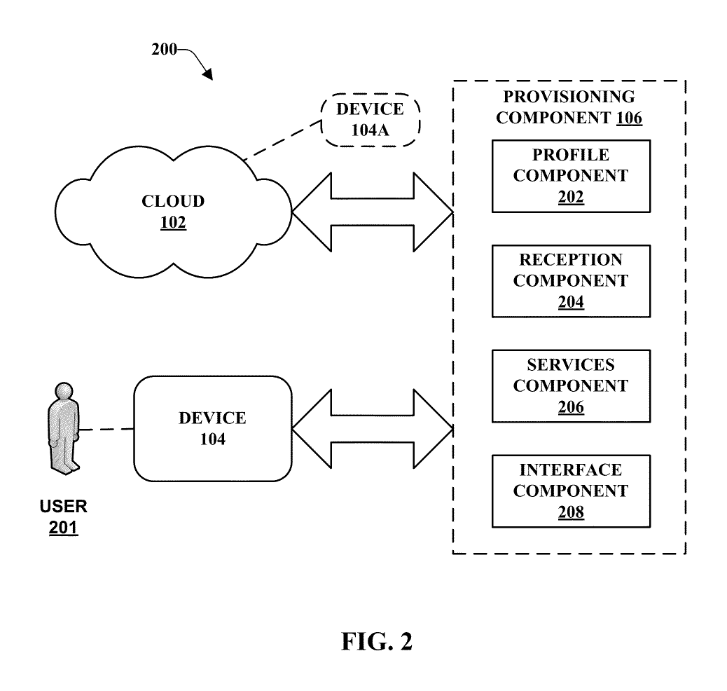

Turning to FIG. 2, illustrated is a system 200 that can provision devices via a cloud service (e.g., cloud) 102 in accordance with various aspects described herein. As discussed previously, the system 200 includes the cloud service 102, the device 104, and the provisioning component 106. The cloud service 102 is configured to maintained or provide services for a set of devices, and the provisioning component 106 is configured to determine a set of the services (e.g., configuration, device profile, setup, etc.) available for the device 104, and provision the device 104 with one or more services from the cloud service 102 based on one or more criterion (e.g., user privileges, preferences, behavior profiles, locations, device specifications, cloud service 102 policies, etc.).

The provisioning component 106 can include a profile component 202, a reception component 204, a services component 206, and an interface component 208. The profile component 202 is configured to confirm, verify, or otherwise authenticate an identity of a user 201 of the device 104, and locate, acquire or otherwise determine a profile (e.g., account, etc.) associated with the user 201, or the device 104, that is maintained by the cloud service 102. For example, the profile component 202 can determine that the user 201 was also a user of the device 104A, and that the user's 201 profile included a set of services. For instance, the user's 201 set of services could have included an operating system (OS), a set of applications, a set of settings for the device 104A, and storage of data generated via the device 104A.

The reception component 204 acquires, obtains, or otherwise receives a request for one or more services. For example, the user 201 may have lost the device 104A that was similar, or identical, to the device 104. The user 201 may desire to configure the device 104 based on a configuration of the device 104A, wherein the configuration of the device 104A is maintained by the cloud service 102. The request to configure the device can be made via the device 104. Additionally or alternatively, the request for services can be made via a disparate device, or by an authorized administrator, such as an information technology (IT) professional, or a customer service representative (CSR). For example, a user can purchase a new mobile phone (e.g., device 104) at a consumer electronics store, and a CSR at the store can setup (e.g., configure) the new mobile phone based on the user's 201 previous mobile phone via the provisioning component 106.

The services component 206 is configured to provision the device 104 with a set of requested services associated with the profile. The services component 206 can check, ensure, or otherwise confirm compatibility of the services maintained by the cloud service 102 with the device 104. In addition, the services component 206 can map incompatible services to corresponding compatible services for the device 104. Returning again to the previous example, if the device 104 is a newer model of the device 104A, then a subset of the services associated with the device 104A may be incompatible with the device 104. The services component 206 can determine compatible services corresponding to the subset of services for the device 104, such as newer versions, updates, alternatives, etc.

Additionally or alternatively, the services component 206 can be further configured to provision the device 104 with a set of dynamically determined services as a function of a set of dynamic provisioning criterion. The set of dynamic provisioning criterion can include, but is not limited to, a location of the device 104 or user 201, demographic information of the user 201 (e.g., age, residence, etc.), a set of specifications for the device 104, a set of cloud service 102 policies, or a usage pattern (e.g., behavior profile) determined for the user 201. For example, the services component 206 can provision a first set of dynamically determined services (e.g., enterprise services) for the device 104 when the user 201 is at work, and a second set of dynamically determined services (e.g., personal services) when the user 201 is at home. As an additional example, if the user 201 is from a first country (e.g., U.S.A.), and is determined to be in a second country (e.g., Brazil), then the services component 206 can dynamically provision the device 104 with a language translation application (e.g., English to Portuguese), or a currency exchange application (e.g., US Dollars to Brazilian Real). Moreover, the services component 206 can provision a set of settings for the device 104, including security settings, time and calendar settings, wireless connectivity settings, and so forth, wherein the set of settings are dynamically determined and optimized for the second country.

The interface component 208 includes any suitable and/or useful adapters, connectors, channels, communication paths, etc. to integrate the system 200 into virtually any operating and/or database system(s). Moreover, the interface component 208 can provide various adapters, connectors, channels, communication paths, etc., that provide for interaction with the system 200. It is to be appreciated that although the interface component 208 is illustrated as incorporated into the provisioning component 106, such implementation is not so limited. For instance, the interface component 208 can be a stand-alone component to receive or transmit data in relation to the system 200.

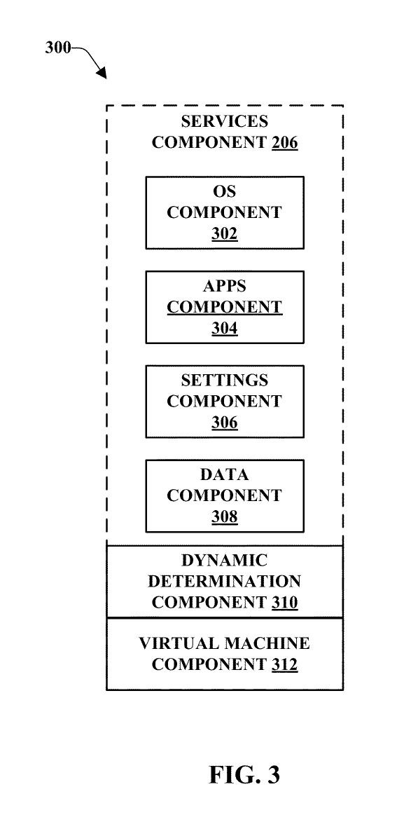

FIG. 3 illustrates an example services component 206 in accordance with various aspects described herein. As discussed supra, the services component 206 is configured to provision the device 104 with a set of requested or dynamically determined services. The services component 206 can include an operating system (OS) component 302, an applications (apps) component 304, a settings component 306, a data component 308, a dynamic determination component 310, and a virtual machine (VM) component 312.

The OS component 302 is configured to provide an operating system, or subcomponent of an operating system, to the device 104. For example, if the cloud service 102 is an enterprise cloud service, and the device 104 is an enterprise device, then the OS component 302 can install, update, or otherwise provide an enterprise OS to the device 104. For instance, the device 104 can initially contain a consumer version of an OS, and an IT professional can request a set of enterprise services for the device 104. The OS component 302 can activate, upgrade, or install the enterprise version of the OS on the device 104. As an additional example, the device 104 may initially have a first operating system, and the user of the device 104 may desire to configure the device 104 in a manner similar to another device employing a second operating system. The OS component 302 can provision the device 104 with the second operating system.

The applications component 304 is configured to install, load, or otherwise provide a set of applications to the device 104. The set of applications can include applications that were previously used on a different device by a common user, applications included a set of enterprise applications (e.g., enterprise application layer), or applications that the user desires to employ on the device 104. For instance, the applications component 304 can provide one or more applications selected by the user 201 from a set of applications available for the device 104 via the cloud service 102. The applications component 304 can determine applications that are available or appropriate for the device 104 based at least in part on a set of OS data obtained from the OS component 302, a set of settings data obtained from the settings component 306, or the profile associated with the user or device 104.

The settings component 306 is configured to determine a set of settings for the device 104, and install, load, or otherwise provide the set of settings to the device 104. Returning to a prior example, the user may desire to configure the device 104 similarly, or identically, to a device 104. The settings component 306 can determine a set of settings that will configure the device 104 as closely as possible to the device 104. As discussed supra, the device 104 can be a newer or different version of the device 104A, wherein some settings may be unavailable on the device 104, or settings that were previously unavailable (e.g., updates) on the first device 104 may be available on the device 104. The settings component 306 can map the settings from the device 104 to settings on the device 104 that mirror the configuration of the first device 104 as closely as possible. Additionally or alternatively, the settings component 306 can determine a set of enterprise settings based on a set of enterprise criterion, and provide the enterprise settings to the device 104. For example, the enterprise settings can enable network or data access, print options, device configuration, and so forth based on the user's identity, position, etc.

The data component 308 is configured to install, restore, or otherwise provide data to the device 104. The data component 308 can transfer data previously acquired from a different device to the device 104. For example, if the user is replacing a device that was lost, stolen, destroyed, etc., (e.g., out-of-service) then the data component 308 can restore the data from the out-of-service device to the device 104. It is to be appreciated that the out-of-service device and the device 104 can be the same device. For example, the memory of the device 104 may have been lost or corrupted. Additionally or alternatively, the data component 308 can provide data to the device 104 based on a set of criterion. For example, the data component 308 can provide a set of engineering specifications and standards to the device 104, where the device is used in an engineering firm.

The data component 308 can be further configured to backup, save, or otherwise maintain data generated via the device 104 to the cloud service 102. For example, the device 104 can be used to create a presentation, and the data component 308 can save the presentation to the cloud service 102. The data component 308 can save the data generated via the device 104 automatically or upon request. For example, the data component 308 can be continuously operable on the device 104, wherein the data component 308 automatically saves generated data to the cloud service 102. Additionally or alternatively, the device 104, or a user of the device, can instruct the data component 308 to backup a set of data to the cloud service 102. The data component 308, or a subcomponent of the data component 308, can be integrated into an operating system on the device 104 to facilitate the transfer of data to and/or from the cloud service 102.

The dynamic determination component 310 (determination component 310) can automatically decide, select, or otherwise determine a set of services to provision for the device 104. The determination component 310 can determine the set of services as a function of a set of dynamic provisioning criterion. The set of dynamic provisioning criterion can include a location of the device 104/user 201, a set of demographic information associated with the user 201, a set of specifications for the device 104, a set of cloud service 102 policies, a usage pattern (e.g., behavior profile) determined for the user 201, and so forth. For example, the determination component 310 can determine a set of applications to be provisioned via the apps component 304, and a set of settings to be provisioned via the settings component 306 based at least in part on the location of the user 201 and/or device 104.

The virtual machine component 312 is configured to generate, provide, or otherwise a provision a virtual machine in the cloud service 102 based on the OS component 302, the applications component 304, the settings component 306, and/or the data component 308. For example, the virtual machine component 312 can provision a VM that is accessible via the device 104, and that executes an operating system, or equivalent, provided by the OS component 302. The VM can enable use of a set of applications provided by the applications component 304, can be configured based on a set of settings determined by the settings component 306, and can include data provided by the data component 308. The virtual machine component 312 can provision the VM in the cloud service 102 based on a request (e.g., from a user, admin, etc.), or based on one or more criterion.

For instance, the device 104 may be the user's personal laptop, and the user can also have an enterprise laptop (e.g., work computer) associated with the cloud service 102. If, the user does not desire to download a complete configuration of the work computer to the device 104, but requests access to the functionality of the work computer from the device 104, the virtual machine component 312 can provision a VM in the cloud service 102 based on the user's work computer. As an additional or alternative example, if the user is replacing an out-of-service device with the device 104, and the services component 206 determines that a time to install a configuration of the out-of-service device on the device 104 exceeds a predetermined download time threshold, then the virtual machine component 312 can provision a VM in the cloud based on the out-of-service device, in order to provide the user with the functionality of the out-of-service device as quickly as possible.

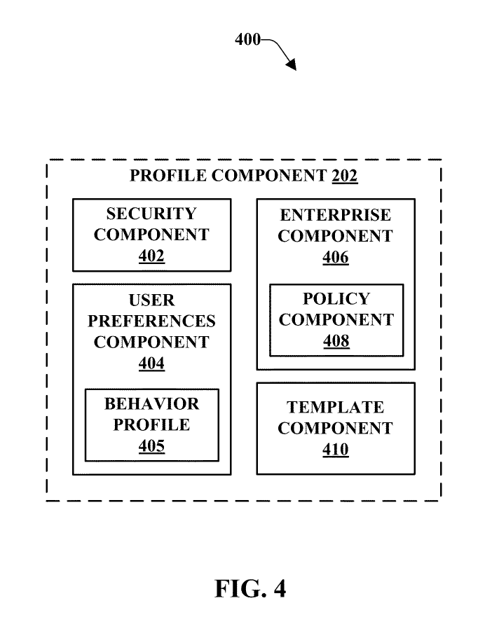

Referring to FIG. 4, illustrated is an example profile component 202 in accordance with various aspects described herein. As discussed supra, the profile component 202 is configured to locate, acquire or otherwise determine a profile (e.g., identity, account, etc.) maintained by the cloud service 102 that is associated a user of a device (e.g., device 104). The profile component 202 can include a security component 402, a user preferences component 404, an enterprise component 406, and a template component 410.

The security component 402 is configured to facilitate confirming, verifying, or otherwise authenticating the identity of a user (e.g., account, etc.) associated with the cloud service 102. The security component 402 can employ a plurality of techniques to facilitate authenticating the profile, including, but not limited to, a set of user credentials (e.g., username, password, etc), biometrics, voice recognition, public-key cryptography, and so forth. Services available to the device 104 can be limited or restricted until a user's profile is verified by the security component 402. For example, the cloud service 102 can have a set of public services available to unverified accounts, such as a limited amount of storage space, or a set of free applications.

The user preferences component 404 is configured to store, save, or otherwise maintain one or more sets of user preferences associated with the profile and/or device 104. The sets of user preferences can include virtually any preferences related to the cloud service 102, the device 104, or the provisioning component 106. For example, the sets of user preferences can include a first set of personal user preferences, for when the device 104 is being used as personal device, and a second set of enterprise preferences, for when the device is being used as a work device (e.g., enterprise device). The personal preferences can dictate that the device 104 be provisioned to include a first set of applications, employ a first set of settings, and so forth. In contrast, the work preferences can dictate that the device 104 be provisioned to include a second set of applications, employ a second set of settings, and so forth. As an additional example, the user preferences component 404, can include different preferences depending on the user of the device. For example, the device 104 can be a laptop that is shared by a family, and the user preferences component 404 can maintain a set of user preferences for the different members of the family that share the device 104.

The user preferences component 404 can include a behavior profile 405. The behavior profile 405 can automatically or selectively track, record, or maintain usage patterns of the cloud service 102, or device 104, for the user 201. The usage patterns can include, but are not limited to, location based usage patterns, time/date based usage patterns, usage of applications, settings, data storage, online shopping, gaming, wireless connectivity, and so forth. As discussed supra, the behavior profile 405 can facilitate dynamic determination of services to provision for the user 201 or device 104. It is to be appreciated that the behavior profile 405 can be selectively activated, deactivated, or modified by the user 201.

The enterprise component 406 is configured to enable installation, maintenance, and/or administration of an enterprise configuration or a set of enterprise services on the device 104. The enterprise component 406 can verify that the profile has authority to access a set of enterprise services available via the cloud service 102 (e.g., enterprise privileges). For example, the security component 402 can verify the identity of a user of the device as an IT professional. The enterprise component 406 can verify that the IT professional's enterprise privileges include access to a set of enterprise services via the cloud service 102, and the IT professional can install or maintain one or more of the enterprises services on the device 104.

The enterprise component 406 can include a policy component 408 that is configured to determine that the device 104 satisfies a set of enterprise policies before enabling access to the enterprise services. The set of enterprise policies can include a set of hardware specifications, a set of security policies, a set of software specifications, a set of settings, a set of supported devices, and so forth. For example, a company's IT department may only support a first and a second operating system. The policy component 408 can determine if the device 104 is operating on either the first or the second operating system. As an additional example, a set of enterprise security policies can prohibit using devices containing predetermined types of applications, and the policy component 408 can determine if the device contains the predetermined types of applications.

The template component 410 is configured to enable the profile to access a set of services, or a set of templates of services (e.g., service templates or templates), not associated with the profile. For example, another user of the cloud service 102 (e.g., a friend of the user) can recommend (e.g., enable access to) a template to configure the device 104, based on the friend's configuration of a similar device that is maintained by the cloud service 102. Additionally, a set of public templates can be available via the cloud service 102. As an additional example, if the enterprise component 406 verifies the profile is associated with an engineering firm, then the template component 410 can enable access to a set of enterprise service templates configured by the engineering firm. The set of enterprise service templates can configure devices based on the duties of various positions at the firm. One template can include a set of applications that engineers at the firm commonly use, a set of settings for the device 104, and so forth.

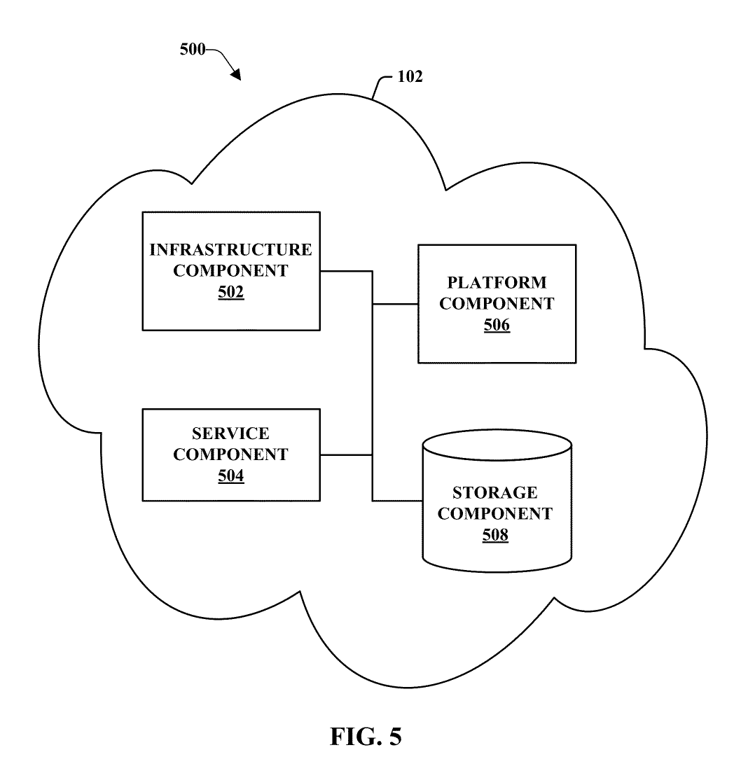

FIG. 5 illustrates an example cloud service 102 in accordance with various aspects described herein. As discussed supra, the cloud service 102 is configured to maintain and/or provide a set of services for a set of devices via a network connection. The cloud service 102 can include an infrastructure component 502, a service component 504, a platform component 506, and a storage component 508. The infrastructure component 502 is configured to provide a set of infrastructure services, such as computer infrastructure, platform virtualization, hardware virtualization, and so forth. In addition, the infrastructure component 502 can be configured to provide operations and maintenance features for the cloud service 102. For example, the infrastructure component 510 can manage accounts (e.g., profiles), billings, security, and so forth. The infrastructure component 502 can be comprised of one or more servers, computing devices, data stores, communications networks, etc.

The service component 504 can be configured to provide services, including, but not limited to, computation, applications (e.g., software, programs, etc.), data access, and device configurations (e.g., settings, etc.) to the devices. The platform component 506 can be configured to provide provisioning capabilities, including resources that facilitate generating and providing applications and services from the cloud service 102. For example, a VM can be provisioned in the cloud service 102 that includes a set of services provided by the service component 504, wherein the platform component 506 provides a set of resources that facilitate provisioning the VM in the cloud service 102. The storage component 508 can be configured to store, save, or otherwise maintain data, settings, applications, configurations, and so forth associated with the cloud service 102. As discussed previously, data generated by devices associated with the cloud service 102 can be dynamically, or statically, stored via the storage component 508.

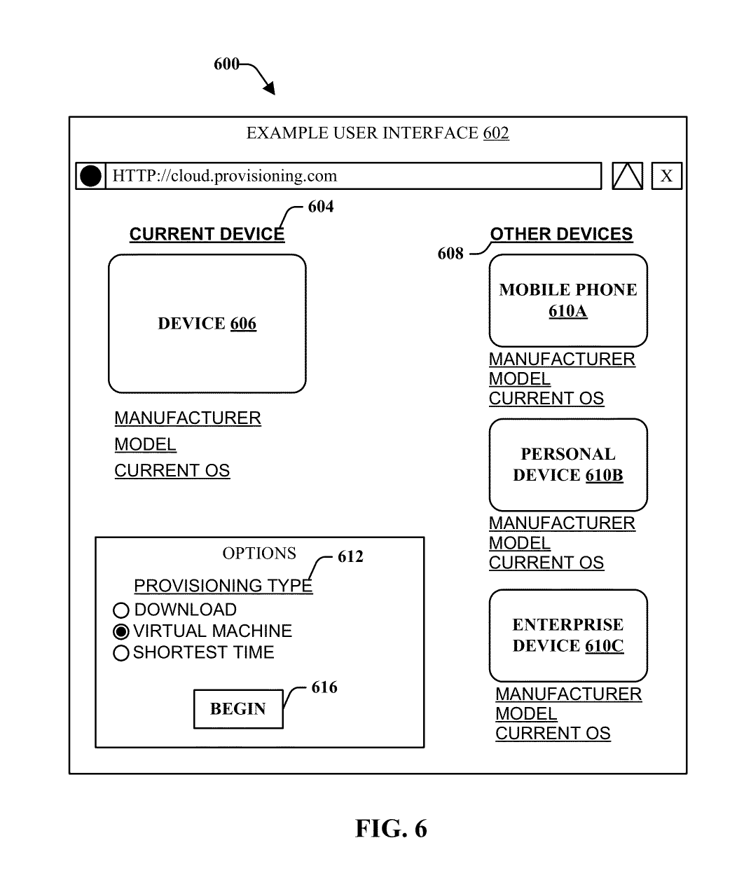

Referring to FIG. 6, illustrated is a system 600 that provides a non-limiting example of a user interface 602 in accordance with various aspects described herein. The interface 602 can be accessed via an internet portal. Additionally or alternatively, the interface 602 can be accessed via an application executing locally on a device. The interface component 602 can include a current device section 604 that exposes a device 606 for which services are being requested from the cloud service 102. In addition, the current device section 604 can display information relating to the device 606, including but not limited to, a manufacturer, a model, an operating system, a set of applications, a set of profile (e.g., account) information, and so forth.

An other devices section 608 can expose information relating to a set of other devices 610 (e.g., devices 610A-C), and a set of information relating to the other devices 610. The other devices 610 can be devices also associated with a profile associated with the device 606. For example, a user of the device of 606 can also have a mobile phone 610A, a personal device (e.g., laptop, tablet, etc.) 610B, and an enterprise device 610C associated with the cloud service 102. Additionally or alternatively, the other devices section 608 can be templates that a user can access. For example, it can be determined that the user has access to a set of enterprise services, and the enterprise device 610C can be a template included in the set of enterprise services. In addition, the other devices section 608 can enable a user to select one of the other devices 610 on which to base a configuration of the device 606. For example, the user may have lost the mobile phone 610A, and desires to provision a new mobile phone (e.g., device 606) based on the configuration of the mobile phone 610A.

A provisioning type section 612 can contain a set of options for provisioning the device 606. For example, the set of options can include a download option, a virtual machine option, and a shortest time option. If the user wishes to replace one of the other devices 610 with the device 606, then the user may desire to download the configuration of the other device 610 to the device 606. However, if the user wishes to temporarily access the functionality of the other device, then the user may select to provision a virtual machine in the cloud service 102 that includes the services of the other device 610. Additionally, if the user desires to provision the device 606 based on the other device 610, but also desires to access the functionality of the other device 610 as quickly as possible, then the user may select the shortest time provisioning option, wherein a first subset of services can be downloaded to the device 606, and a second subset of services can be included in a virtual machine that executes in the cloud service 102, in order to provide for the quickest possible access to the functionality of the other device 610C.

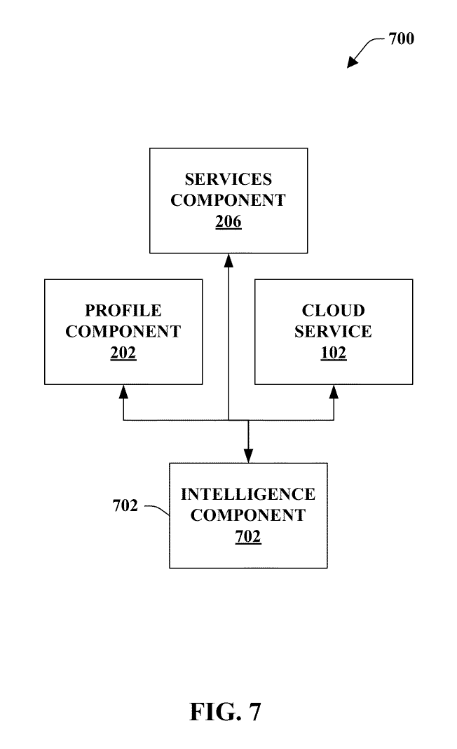

Referring now to FIG. 7, system 700 that can provide for or aid with various inferences or intelligent determinations is depicted. Generally, system 700 can include all or a portion of the profile component 202, the services component 206, and the cloud service 102 as substantially described herein. In addition to what has been described, the above-mentioned components can make intelligent determinations or inferences. For example, services component 206 can intelligently determine or infer a set of services to provide to the device 104.

Likewise, the profile component 202 can also employ intelligent determinations or inferences in connection with verifying a user's identity, or enabling access to a set of services. In addition, the cloud service 102 can intelligently determine or infer a set of platform services, and facilitate generation of a VM using the platform services. Any of the foregoing inferences can potentially be based upon, e.g., Bayesian probabilities or confidence measures or based upon machine learning techniques related to historical analysis, feedback, and/or other determinations or inferences.

In addition, system 700 can also include an intelligence component 702 that can provide for or aid in various inferences or determinations. In particular, in accordance with or in addition to what has been described supra with respect to intelligent determination or inferences provided by various components described herein. For example, all or portions of the profile component 202, the services component 206, and the cloud service 102 (as well as other components described herein) can be operatively coupled to intelligence component 702. Additionally or alternatively, all or portions of intelligence component 702 can be included in one or more components described herein. Moreover, intelligence component 702 will typically have access to all or portions of data sets described herein, such as in the storage component 508.

Accordingly, in order to provide for or aid in the numerous inferences described herein, intelligence component 702 can examine the entirety or a subset of the data available and can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

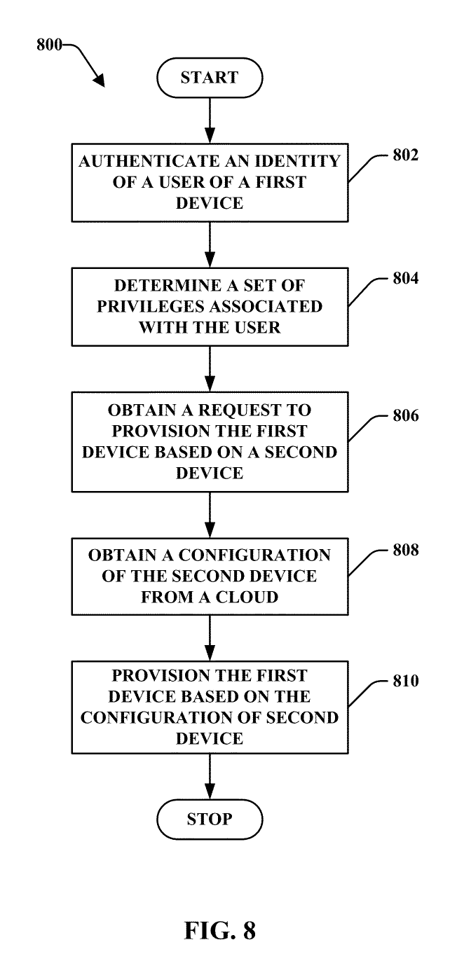

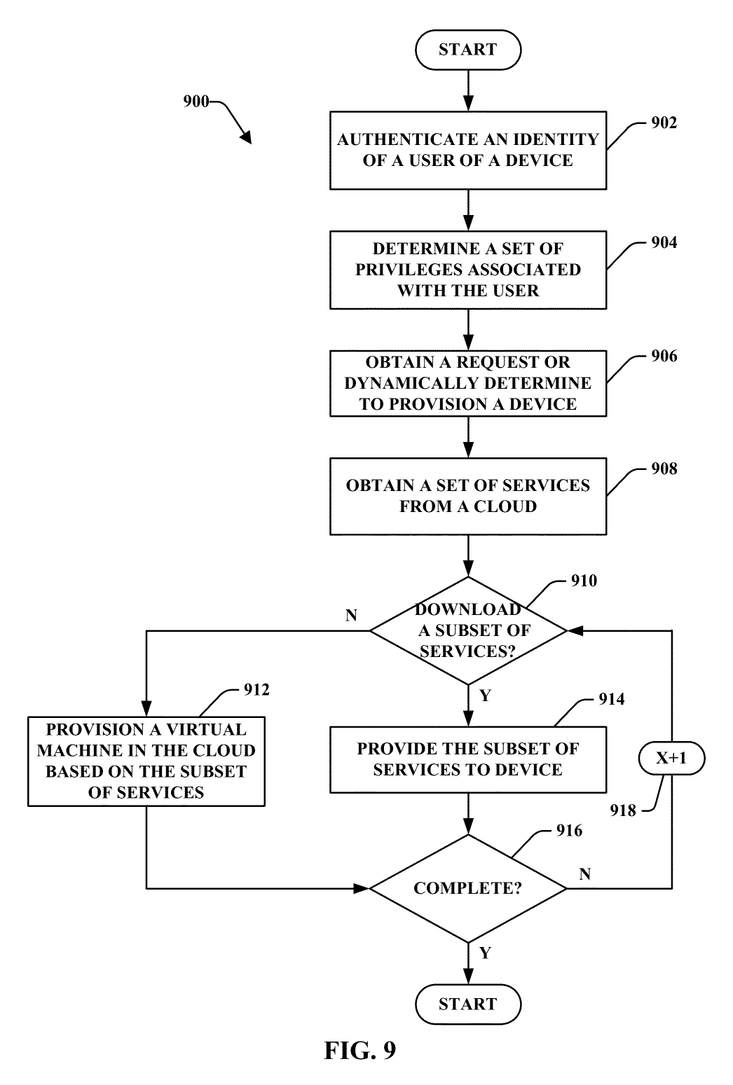

In view of the example systems described supra, methods that may be implemented in accordance with the disclosed subject-matter may be better appreciated with reference to the flow charts of FIGS. 8-9. While for purposes of simplicity of explanation, the methods are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

With reference to FIG. 8, illustrated is an example method 800 for device provisioning via a cloud service (e.g. cloud) in accordance with various aspects described herein. At reference numeral 802, an identity of a user of a first device can be confirmed, verified, or otherwise authenticated. For example, the identity of the user can be authenticated via a set of user credentials (e.g., username, password, etc), biometrics, voice recognition, public-key cryptography, and so forth.

At reference numeral 804, a set of privileges associated with the user can be determined The set of privileges can include, access to the cloud, access to a set of services provided via the cloud, access to a set of enterprise services or templates available via the cloud, access to a set of services or templates associated with a disparate user available via the cloud, and so forth. The services can include, but are not limited to, computation, applications (e.g., software, programs, etc.), data access, settings, and storage (e.g., data backup).

At reference numeral 806, a request to provision a first device based on a configuration of a second device can be obtained. For example, the second device can be an enterprise laptop that has become inoperable, wherein the user desires to provision a new laptop based on the inoperable enterprise laptop. It is to be appreciated that if a device is inoperable, lost, stolen, damaged, etc., it may be difficult to transfer data, settings, applications, and so forth from the device to another device. At reference numeral 808, a configuration of the second device can be obtained from the cloud. The configuration can include one or more services. For example, the configuration of the second device can include an operating system (OS), a set of applications, a set of settings, and data backed-up via the cloud.

At reference numeral 810, the first device can be provisioned based on the configuration of the second device. Continuing with the previous example, the operating system (OS), set of applications, set of settings, and data backed-up via the cloud can be communicated from the cloud to the device (e.g., downloaded). Additionally or alternatively, the configuration of the second device, or a portion of the configuration, can be used to provision a virtual machine (VM) in the cloud that can be accessed by the first device.

Turning to FIG. 9, illustrated is an example method 900 for device provisioning via a cloud service (e.g. cloud) in accordance with various aspects described herein. At reference numeral 902, an identity of a user of the first device can be confirmed, verified, or otherwise authenticated. For example, the identity of the user can be authenticated via a set of user credentials (e.g., username, password, etc), biometrics, voice recognition, public-key cryptography, and so forth.

At reference numeral 904, a set of privileges associated with the user can be determined The set of privileges can include, access to the cloud, access to a set of services provided via the cloud, access to a set of enterprise services or templates available via the cloud, access to a set of services or templates associated with a disparate user available via the cloud, and so forth. The services can include, but are not limited to, computation, applications (e.g., software, programs, etc.), data access, device configurations (e.g., settings, etc.), and storage (e.g., data backup).

At reference numeral 906, a request to provision a first device can be obtained. For example, the user of the first device can desire to utilize the first device as an enterprise device, and can request to provision the first device based on an enterprise service template. Additionally or alternatively, it can be dynamically determined to provision the device as a function of a set of dynamic provisioning criterion. For example, it can be dynamically determined to provision a set of applications and settings for the device based at least in part on the location of the user or device. At reference numeral 908, a set of services can be obtained from the cloud. For example, the services can include an operating system (OS), a set of applications, a set of settings, and a set of data, and so forth.

At reference numeral 910, a determination is made whether to download a subset of the services to the device. The set of services can include X subsets of services, where X is an integer greater than or equal to 1. The determination can be based on a set of criterion, including, but are not limited to, user input, the set of privileges associated with the user, capabilities of the device, or a predetermined download time threshold. For example, the user can determine not to download a subset of the services to the device, because the user only desires temporary access to the services. As an additional example, the user can desire for the subset of services to be downloaded to the device, and also desire immediate access to the subset of services. Therefore, if the time to download the subset of services to the device, exceeds the predetermined download time threshold, then the subset of services can be downloaded to the device, and included in a virtual machine executing in the cloud.

At reference numeral 912, if the subset of services are not downloaded to the device (N at reference numeral 910), then a virtual machine can be provisioned in the cloud that includes the subset of services, and the method advances to reference numeral 916. Returning to reference numeral 910, if the subset of services are downloaded to the device, then at reference numeral 914 the subset of services are provided to the device via a network connection. Returning to the previous example, the subset of services can be both downloaded to the device at reference numeral 914, and included in a virtual machine at reference numeral 912.

At reference numeral 916, a determination is made whether the provisioning of the device is complete. For example, if the set of services includes six subsets of services (e.g., X=6), then a determination can be made whether the six subsets of services have been downloaded (at reference numeral 914), and/or included in a virtual machine (at reference numeral 912). If the provisioning is not complete (N at reference numeral 916), then the method advances to the next subset of services at reference numeral 918, and returns to reference numeral 910. If the methodology is complete (Y at reference numeral 916), then the method can terminate.

### Exemplary Networked and Distributed Environments

One of ordinary skill in the art can appreciate that the various embodiments for network provisioning of devices described herein can be implemented in connection with any computer or other client or server device, which can be deployed as part of a computer network or in a distributed computing environment, and can be connected to any kind of data store. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the mechanisms for network provisioning of devices as described for various embodiments of the subject disclosure.

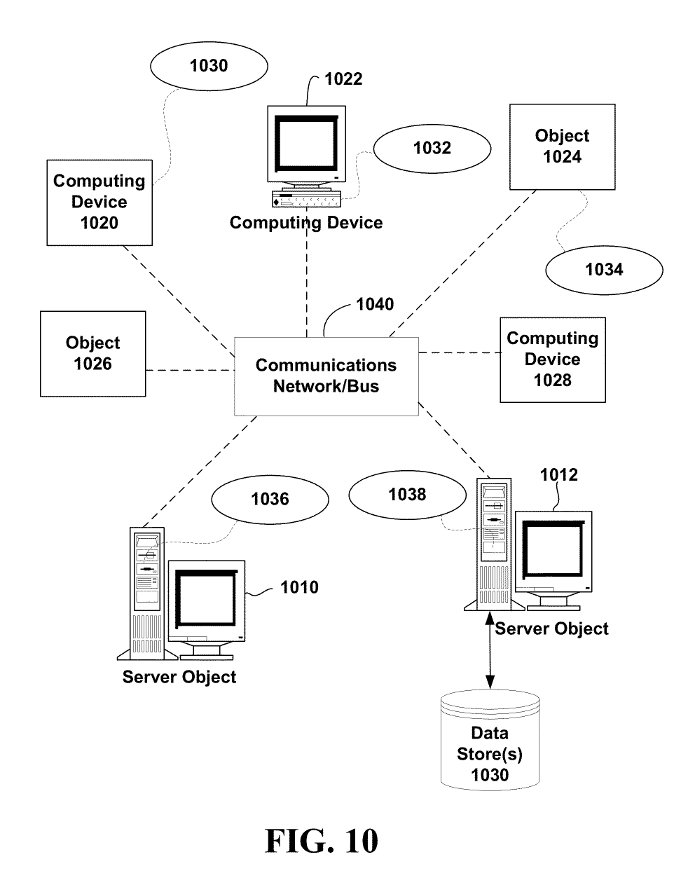

FIG. 10 provides a schematic diagram of an exemplary networked or distributed computing environment. The distributed computing environment comprises computing objects 1010, 1012, etc. and computing objects or devices 1020, 1022, 1024, 1026, 1028, etc., which may include programs, methods, data stores, programmable logic, etc., as represented by applications 1030, 1032, 1034, 1036, 1038 and data store(s) 1040. It can be appreciated that computing objects 1010, 1012, etc. and computing objects or devices 1020, 1022, 1024, 1026, 1028, etc. may comprise different devices, such as personal digital assistants (PDAs), audio/video devices, mobile phones, MP3 players, personal computers, laptops, etc.

Each computing object 1010, 1012, etc. and computing objects or devices 1020, 1022, 1024, 1026, 1028, etc. can communicate with one or more other computing objects 1010, 1012, etc. and computing objects or devices 1020, 1022, 1024, 1026, 1028, etc. by way of the communications network 1042, either directly or indirectly. Even though illustrated as a single element in FIG. 10, communications network 1042 may comprise other computing objects and computing devices that provide services to the system of FIG. 10, and/or may represent multiple interconnected networks, which are not shown. Each computing object 1010, 1012, etc. or computing object or devices 1020, 1022, 1024, 1026, 1028, etc. can also contain an application, such as applications 1030, 1032, 1034, 1036, 1038, that might make use of an API, or other object, software, firmware and/or hardware, suitable for communication with or implementation of the techniques for network provisioning of devices provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems for network provisioning of devices as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 10, as a non-limiting example, computing objects or devices 1020, 1022, 1024, 1026, 1028, etc. can be thought of as clients and computing objects 1010, 1012, etc. can be thought of as servers where computing objects 1010, 1012, etc., acting as servers provide data services, such as receiving data from client computing objects or devices 1020, 1022, 1024, 1026, 1028, etc., storing of data, processing of data, transmitting data to client computing objects or devices 1020, 1022, 1024, 1026, 1028, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1042 or bus is the Internet, for example, the computing objects 1010, 1012, etc. can be Web servers with which other computing objects or devices 1020, 1022, 1024, 1026, 1028, etc. communicate via any of a number of known protocols, such as the hypertext transfer protocol (HTTP). Computing objects 1010, 1012, etc. acting as servers may also serve as clients, e.g., computing objects or devices 1020, 1022, 1024, 1026, 1028, etc., as may be characteristic of a distributed computing environment.

### Exemplary Computing Device

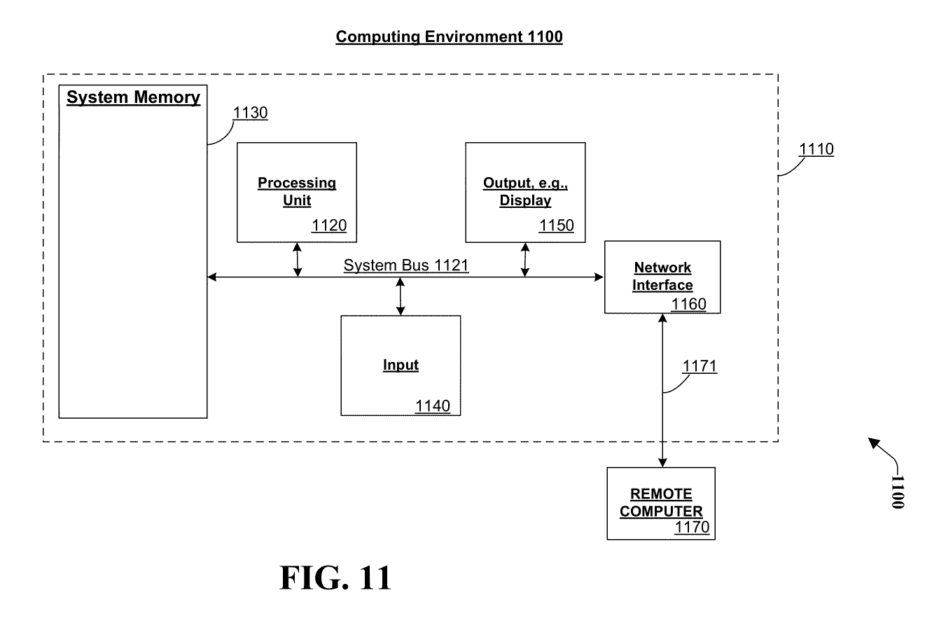

As mentioned, advantageously, the techniques described herein can be applied to any device where it is desirable to perform network provisioning of devices in a computing system. It can be understood, therefore, that handheld, portable and other computing devices and computing objects of all kinds are contemplated for use in connection with the various embodiments, i.e., anywhere that resource usage of a device may be desirably optimized. Accordingly, the below general purpose remote computer described below in FIG. 11 is but one example of a computing device.

Although not required, embodiments can partly be implemented via an operating system, for use by a developer of services for a device or object, and/or included within application software that operates to perform one or more functional aspects of the various embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol should be considered limiting.

FIG. 11 thus illustrates an example of a suitable computing system environment 1100 in which one or aspects of the embodiments described herein can be implemented, although as made clear above, the computing system environment 1100 is only one example of a suitable computing environment and is not intended to suggest any limitation as to scope of use or functionality. Neither should the computing system environment 1100 be interpreted as having any dependency or requirement relating to any one or combination of components illustrated in the exemplary computing system environment 1100.

With reference to FIG. 11, an exemplary remote device for implementing one or more embodiments includes a general purpose computing device in the form of a computer 1110. Components of computer 1110 may include, but are not limited to, a processing unit 1120, a system memory 1130, and a system bus 1122 that couples various system components including the system memory to the processing unit 1120.

Computer 1110 typically includes a variety of computer readable media and can be any available media that can be accessed by computer 1110. The system memory 1130 may include computer storage media in the form of volatile and/or nonvolatile memory such as read only memory (ROM) and/or random access memory (RAM). By way of example, and not limitation, system memory 1130 may also include an operating system, application programs, other program modules, and program data. According to a further example, computer 1110 can also include a variety of other media (not shown), which can include, without limitation, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information.

A user can enter commands and information into the computer 1110 through input devices 1140. A monitor or other type of display device is also connected to the system bus 1122 via an interface, such as output interface 1150. In addition to a monitor, computers can also include other peripheral output devices such as speakers and a printer, which may be connected through output interface 1150.

The computer 1110 may operate in a networked or distributed environment using logical connections, such as network interfaces 1160, to one or more other remote computers, such as remote computer 1170. The remote computer 1170 may be a personal computer, a server, a router, a network PC, a peer device or other common network node, or any other remote media consumption or transmission device, and may include any or all of the elements described above relative to the computer 1110. The logical connections depicted in FIG. 11 include a network 1172, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system.

In addition, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating there from. Still further, multiple processing chips or multiple devices can share the performance of one or more functions described herein, and similarly, storage can be effected across a plurality of devices. Accordingly, the invention should not be limited to any single embodiment, but rather should be construed in breadth, spirit and scope in accordance with the appended claims.

What is claimed is:

1. A computing device, comprising:
a memory having computer executable components stored thereon; and
a processor communicatively coupled to the memory, the processor configured to facilitate execution of the computer executable components, the computer executable components, comprising:
a profile component configured to authenticate a user of a device with a network service, and determine services maintained by the network service that are associated with the user;
a reception component configured to receive a request for a set of services from the device; and
a services component configured to obtain the set of services from the network service, and provision the device based on the set of services.

2. The computing device of claim 1, wherein the set of services includes at least one of an operating system, a set of applications, a set of settings, or a set of data.

3. The computing device of claim 1, wherein the set of services include services employed in a configuration of a disparate device.

4. The computing device of claim 1, further comprising an enterprise component configured to determine that the user is associated with an enterprise, and in response to the user being associated with the enterprise, provide a set of enterprise services to the device.

5. The computing device of claim 4, further comprising a policy component configured to enforce a set of enterprise policies.

6. The computing device of claim 1, further comprising a virtual machine component configured to provision a virtual machine that executes in the network service and includes the set of services, wherein the virtual machine can be accessed by the device.

7. The computing device of claim 1, further comprising a dynamic determination component configured to automatically determine the set of services to provide to the device.

8. The computing device of claim 1, wherein the services component is further configured to determine that a subset of the services are incompatible with the device, and in response to the subset of the services being incompatible with the device, map the subset of services to another set of services that are compatible with the device.

9. A method, comprising:
authenticating an identity of a user of a first device with a network service;
determining a set of privileges associated with the user;
obtaining a request to provision the first device based on a configuration of a second device maintained by the network service; and
provisioning the first device based on the configuration of the second device.

10. The method of claim 9, wherein the determining the set of privileges associated with the user, includes determining a set of enterprise privileges associated with the user.

11. The method of claim 10, wherein the determining the set of enterprise privileges associated with the user, includes enabling access for the user to at least one of a set of enterprise services, or set of enterprise service templates.

12. The method of claim 9, wherein the provisioning the first device further comprises downloading a first set services included in the configuration to the device.

13. The method of claim 10, wherein the provisioning the first device further comprises provisioning a virtual machine based on at least one of: the first set of services, or a second set of services included in the configuration.

14. The method of claim 9, wherein the obtaining the request to provision the first device based on a configuration of a second device maintained by the network service, includes obtaining the request to provision the first device based on the configuration of the second device, wherein the second device is associated with a disparate user.

15. The method of claim 9, wherein the provisioning the first device based on the configuration of the second device, includes provisioning the first device based on at least one of an operating system, a set of applications, a set of settings, or a set of data included in the configuration of the second device.

16. A computer-readable storage device comprising computer-readable instructions that, in response to execution, cause a computing system to perform operations, comprising:
verifying an identity of a user of a device with a network;
obtaining a set of services from the network; and
determining to download a first subset of the services to the device based on a set of criterion.

17. The computer-readable storage device of claim 16, further comprising at least one of: obtaining a request to provision the device for the set of services, or dynamically determining the set of services to provision for the device.

18. The computer-readable storage device of claim 16, further comprising determining to include at least one of the first subset of the services, or a second subset the services in a virtual machine executing in the network based on the set criterion.

19. The computer-readable storage device of claim 18, wherein the obtaining the set of services includes determining the user has access to a set of enterprise services, and obtaining a set of enterprise services.

20. The computer-readable storage device of claim 16, wherein the obtaining the set of services includes obtaining at least one of an operating system, a set of applications, a set of settings, or a set of data.
